(19) United States
(12) Patent Application Publication
(10) Pub. No.: US 2012/0007747 A1
(43) Pub. Date: Jan. 12, 2012

(54) METHOD AND SYSTEM FOR TRANSMITTING DATA FROM A DEVICE TO A RECEIVING UNIT

(75) Inventors: Volker Boike, Lennestadt (DE); Elmar Koch, Eslohe (DE)

(73) Assignee: Rayonex Schwingungstechnik GbmH, Lennestadt (DE)

(21) Appl. No.: 13/140,155

(22) PCT Filed: Dec. 16, 2009
(86) PCT No.: PCT/EP2009/009027

§ 371 Date: Aug. 23, 2011

(30) Foreign Application Priority Data
Dec. 17, 2008 (DE) 102008062754.2

(51) Int. Cl. H04B 13/02; G01V 3/12

(52) U.S. Cl. 340/856.3; 455/40

(57) ABSTRACT

The invention relates to a method for transmitting data from a device, such as is used in endoscopy or microsurgery, for example, to a receiving unit, wherein a magnetic dipole disposed in or on the device is rotationally driven, the data are generated by a change in the rotational frequency of the magnetic dipole, and the changing magnetic field of the magnetic dipole is received and analyzed by the receiving unit, wherein the rotational speed range in which the magnetic dipole can be driven is divided into partial ranges, each associated with a type of data.

The invention relates to a method and a system for transmitting data from a device of a type used, for example, in endoscopy or micro-surgery to a receiving unit, with a magnetic dipole arranged in or on the device, wherein the dipole is rotationally driven by a drive, whereby the data are generated by changing the rotation frequency of the magnetic dipole and the changing magnetic field of the magnetic dipole is received by the receiving unit and evaluated.

Micro-surgical and endoscopic instruments used in medicine are used in particular for diagnostic purposes and in surgery on sensitive or difficult to access tissues and organs. These interventions are typically performed under computer and/or camera control and require a high degree of precision for locating, positioning and movement of the instruments. Probe systems, such as magnetic or electromagnetic probes, are used for this purpose. U.S. Pat. Nos. 5,836,869 and 6,248,074 describe fixed magnetic field sources or magnetic field sensors which measure the three spatial coordinates of a moving magnetic field with a three-axes design of the magnet or the sensor. However, this does not allow a spatially precise or temporally accurate determination of the position of the endoscopic device. The reason is that the determination of the magnetic field coordinates described in U.S. Pat. No. 5,836,869 requires the measurement of three different magnetic fields with a three-axes magnet; the magnetic fields are measured sequentially with a time offset to prevent interference, with the individual axes generating electromagnetic signals with a time offset. The measurement is hereby performed external to the patient and also requires a conversion for estimating the position of the endoscope in the body.

U.S. Pat. No. 6,248,074 describes attachment of a magnetic field source external to the patient; localization is hereby performed by determining the position of the detector relative to the external magnetic field with a magnetic field sensor attached at the distal end of the endoscope. Here, too, only a relatively imprecise measurement is possible, because the endoscope and the sensor are moved relative to the fixed magnetic field and hence no exact relationship exists between the stationary magnetic field coordinates and the changing spatial orientation of the sensor. In addition, other detrimental factors affecting the accuracy exist, for example the problem associated with measuring regions having a different distance from the body surface or the undesirable effects on the measurement accuracy caused by external magnetic fields. Conversely, probes placed inside the body are frequently very sensitive and require complex electrical wiring systems or constant use and replacement of batteries.

An improved method for localizing a device compared to the aforedescribed methods is disclosed in WO 2003/103492 A1, which discloses to arrange a magnetic dipole inside the housing of a medical device or, for example, also of a drill head, which is rotationally driven independent of a possible rotation of the housing. For localizing the device, the magnetic field generated by the magnetic dipole is measured by a three-axes magnetometer (fluxgate) and evaluated. In this way, the position of a medical device inside the body of a patient can be exactly determined. To this end, a changing component of the magnetic field, which depends on the roll angle, is generated and measured by the magnetometer, wherein one actual embodiment describes briefly stopping or tilting the dipole in a defined relative orientation with respect to the housing. WO 2003/103492 A1 also discloses in general terms the possibility of transmitting data from the device to the magnetometer by modulating the frequency of the rotation of the magnetic dipole. However, an actual exemplary embodiment of such frequency modulation of the rotation of the dipole is not disclosed in WO 2003/103492 A1. The type of data that can be transmitted is also not disclosed.

It was an object of the invention to advantageously improve the method known from WO 2003/103492 A1 and to more particularly enable the transmission of different (types of) data.

This object is solved by the features of the independent claims. Advantageous embodiments are recited in the respective dependent claims and can be inferred from the following description of the invention.

The idea on which the invention is based relates to transmitting different data types through a frequency modulation of a rotating dipole, which can be achieved by dividing the rotation speed range, in which the magnetic dipole can be rotationally driven, into predefined partial ranges and by associating a concrete data type with one or more of these partial ranges, wherein the data of each data type are transmitted within these partial ranges by a corresponding change of the rotation frequency of the magnetic dipole.

In a corresponding method according to the invention for transmitting data from a device to a receiving unit, data are generated by changing the rotation frequency of a magnetic dipole arranged on the device and the magnetic field of the magnetic dipole is received by a receiving unit and the transmitted data are determined by evaluating the magnetic field. According to the invention, the rotation speed range in which the magnetic dipole can be driven is subdivided into partial ranges, with each partial range being associated with a data type.

A corresponding system according to the invention for transmitting data from a device to a receiving unit includes at least one magnetic dipole arranged in or on the device, which is rotationally driven by a drive (e.g., an electric motor), wherein the changing magnetic field of the magnetic dipole can be received and evaluated by the receiving unit; the system further includes a control unit for intentionally changing the rotation frequency of the magnetic dipole, wherein the rotation speed range in which the magnetic dipole can be driven is subdivided into partial ranges, with each partial range being associated with a data type.

Preferably, the method of the invention and/or the system of the invention is used for transmitting data from a medical and in particular a micro-surgical or endoscopic device to an external receiving unit. However, the method and system are not limited to this application, but can also be used for transmitting data to a receiving unit from a device that is difficult to access. For example, earth working devices and in particular horizontal drilling jigs should here be mentioned.

The term “earth working device” refers to any device configured for creating bore holes, expanding bore holes and pulling pipes or conduits into bore holes in the ground.

The term “ground” refers to any accumulation of a material or mixture of materials in which a bore hole can be introduced; in particular, the term is meant to not only refer to the ground itself, but also to any type of piles of material above ground, for example piles of building materials.

In a particularly preferred embodiment of the method of the invention, for transmitting a particular relatively slowly changing values of a data type, the frequency of the rotating magnetic dipole may be linearly changed in the corresponding partial range of the rotation speed range associated with this data type. In this way, a simple control of the rotation frequency can be attained without jumps in the rotation speed. “Relatively slowly” is intended to indicate that the change in the value of the data type occurs so slowly that the frequency change of the dipole can substantially follow the desired course when taking into account the inertia of the rotating dipole.

For transmitting cyclically changing values of a data type, the frequency may preferably be changed sinusoidally in the corresponding partial range of the rotation speed range associated with this data type. By changing the frequency in form of a sinusoidal oscillation, the data can be transmitted without requiring substantial jumps in the rotation speed of the magnet. This is advantageous because due to the inertia of the system, limits for the control speed may otherwise have to be set. Cyclically changing values of a data type may, for example, relate to information about the roll angle of the device and/or of the housing or of a part of the housing of the device.

Due to the symmetry of a sinusoidal oscillation, a defined value of the data type to be transmitted may occasionally be determinable only with ambiguity, because two data values are associated with each value of the rotation frequency. To filter out this ambiguity of the data values, the frequency change may preferably be additionally modulated in defined segments of the sinusoidal oscillation. This may be accomplished, for example, by dividing the sinusoidal oscillation into individual frequency plateaus, i.e., the fundamental sinusoidal oscillation is briefly held constant at defined frequency values. The separation between the frequency plateaus can be predefined by the system.

In a preferred method according to the invention for transmitting data of the roll of the device which can be rotated about an axis, the roll is preferably subdivided into defined roll values, wherein in each roll value corresponds to a concrete modulation of the sinusoidal frequency change. Due to the inertia of the rotating dipole with respect to a change in its rotation frequency, the roll may preferably not be subdivided into too many defined roll values. For example, a revolution of the rotatable device may be subdivided into twelve positions.

The invention also relates to an inventive method for operating a steerable earth working apparatus which can be rotationally driven by both pushing and pulling as well as rotation, wherein the data are transmitted with a method according to the invention by causing a change in the rotation frequency of the dipole in a first partial range of the rotation speed range of the rotationally driven magnetic dipole, where a relatively low rotation speed is provided, in order to transmit data relating to roll of the earth working apparatus; it is also provided to terminate the frequency change in a second partial range with a higher rotation speed. In this way, the rotating dipole can be used to operate the rotating magnetic dipole in the steering mode of the earth drilling apparatus, i.e., if the earth drilling apparatus is driven only by pushing or pulling and without rotation or only with a relatively small angular velocity, within the first partial range having a relatively low rotation speed, and to make frequency changes which enable transmission of the data relating to the roll of the earth drilling apparatus. Conversely, in the operating mode of the drilling apparatus, i.e., when the drilling apparatus is not only driven by pushing or pulling, but additionally with a (rapid) rotation, the rotation speed of the magnetic dipole may be increased in the second partial range. It is possible that a meaningful frequency modulation for transmission of (in particular cyclically changing) data (e.g., data relating to the roll angle) cannot be performed in this partial range due to the inertia of the magnetic dipole; however, the localization of the earth drilling apparatus in the ground can be significantly improved due to the higher rotation frequency of the magnetic dipole by measuring and evaluating the magnetic field, as is known in the state-of-the-art, because a larger number of measurements of the changing magnetic field can be performed in each time interval. Because transmission of the data with respect to the roll of the earth drilling apparatus during the drilling operation is frequently not required, this data transmission may optionally be omitted.

In a system which is particularly suited for carrying out this method, the device may preferably be rotationally driven independent of the magnetic dipole, wherein the rotation axes of the device and of the magnetic dipole are oriented parallel or coaxially with respect to one another. This allows a simple control of the rotation frequency of the magnetic dipole independent of the rotation of the device and, moreover, due to the parallelism or coaxial arrangement of the rotation axes, a simple evaluation regarding to the orientation of the device, in particular of the earth drilling apparatus in the ground. It is, of course, also possible to incline the rotation axis of the dipole with respect to the rotation axis of the device.

The invention will now be described in more detail with reference to an exemplary embodiment illustrated in the drawings.

The drawings show in:

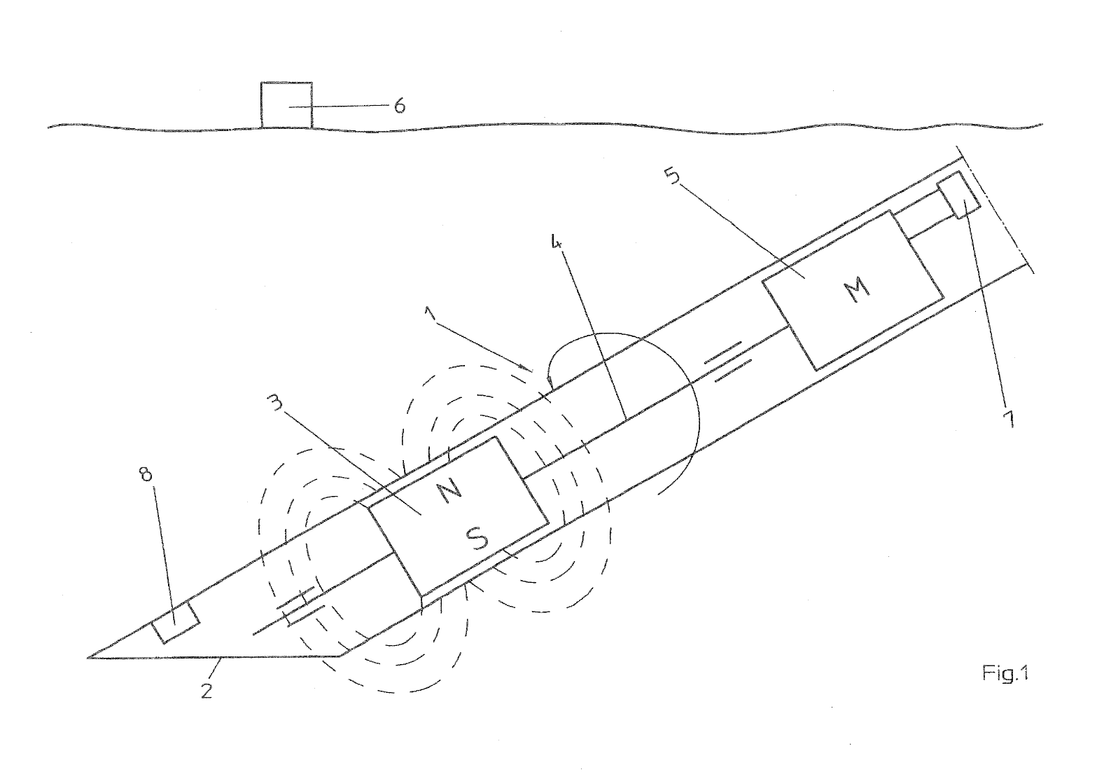

FIG. 1 a system according to the invention with a drill head of a horizontal drilling apparatus in a schematic illustration;

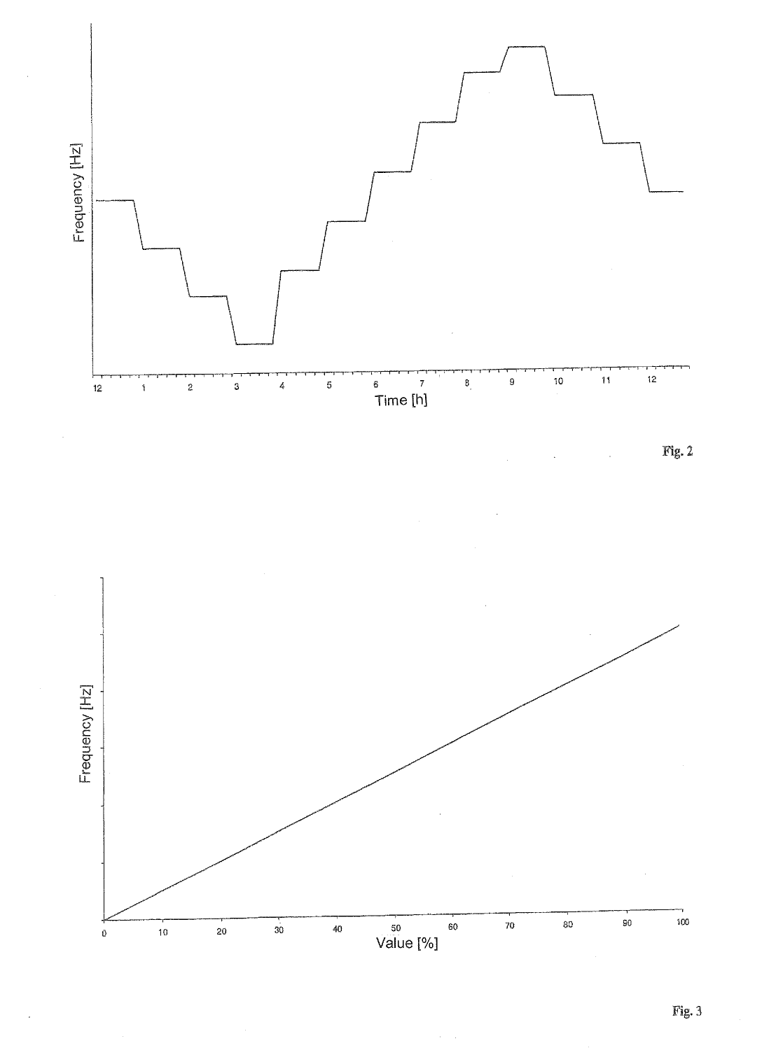

FIG. 2 in a diagram, the course of the frequency modulation of the rotation of a magnetic dipole of the horizontal drilling apparatus of FIG. 1 for transmitting a first data type; and

FIG. 3 in a diagram, the course of the frequency modulation of the rotation of the magnetic dipole for transmitting a second data type.

FIG. 1 shows in a schematic illustration a system according to the invention for transmitting data from a device to a receiving unit. In the present example, the device is a drill head 1 of a horizontal drilling apparatus. This drill head is implemented as an inclined drill head and has a control surface 2 which is inclined with respect to the longitudinal axis of the drill head. The control surface 2 produces during the advance of the drill head 1 through the ground a lateral force, by which the drill head 1 is deflected to an arcuate drill path. The control surface 2 allows controllability of the drill head 1. To intentionally steer the drill head 1 in one direction, rotation of the drill head 1 may intentionally be stopped at a defined angle (roll angle), whereby a corresponding orientation of the control surface 2 in the ground is attained. In a subsequent, purely static advance of the drill head 1 through the ground, the drill head 1 is continuously deflected in a direction defined by the orientation of the control surface 2 and accordingly also by the roll angle of the drill head 1. Conversely, in order to drill a straight borehole with an inclined drill head according to FIG. 1, the drill head 1 may be driven rotationally at the same time the drill head 1 is statically advanced. In this way, the lateral forces on the drill head 1 are equalized over a complete revolution of the drill head 1, thereby producing on average a straight drill path.

A magnetic dipole 3 (in the present example a permanent magnet) is rotationally supported inside the drill head 1. The magnetic dipole 3 is connected via a shaft 4 with an electric motor 5 which drives the dipole. Alternative drives may also employ hydraulic (e.g., by way of a drill flush) or pneumatic drives, for example corresponding turbines. The rotation axis of the dipole 3 is here coaxial with the longitudinal axis of the drill head 1. The rotating magnetic dipole 3 produces a likewise rotating magnetic field, which may be received by a receiving unit 6 embodied preferably as a three-axes magnetometer and arranged, for example, at the surface. With respect to the stationary coordinate system of the receiving unit 6, the rotating magnetic field of the dipole 3 represents a changing magnetic field that changes according to the magnetic field vector describing the magnitude and the direction of the magnetic field. Concretely, the rotating magnetic field vector, the origin of which defines the position of the rotating magnetic dipole, can be determined with the magnetometer. The position of the drill head 1 in the ground can be determined by evaluating with the receiving unit 6 the temporal changes of the magnetic field generated by the magnetic dipole 3. This method for localizing a device by evaluating a magnetic field generated by a rotating magnetic dipole is known in the art. For example, reference is made to DE 102 25 517, WO 2003/103492 A1, DE 10 2004 058 272 A1 and WO 2007/048515 A1, which are incorporated in the present patent application in their entirety because of the methods disclosed therein for determining the position of a rotating magnetic dipole.

The system according to the invention illustrated in FIG. 1 also allows the transmission of data and, more particularly, of several data types by evaluating the magnetic field produced by the magnetic dipole 3. The electric motor 5 is hereby connected with a control unit 7 capable of affecting the rotation of the electric motor 5 and hence the magnetic dipole 3. The rotation frequency of the magnetic dipole 3 can be intentionally controlled with the control unit 7, which in turn affects the magnetic field. The ensuing change of the magnetic field is measured by the receiving unit 6 and can be evaluated accordingly. According to the invention, the change of the rotation of the dipole 3 includes subdividing the rotation speed range within which the magnetic dipole 3 can be rotationally driven into partial ranges which are at least partially associated with a defined data type. A change in the rotation frequency of the magnetic dipole 3 within a defined partial range of the rotation speed range is intended for transmission of the respective associated data type.

The method according to the invention can be used for transmitting any type of data, wherein in the following a concrete and particularly preferred application will be described.

On one hand, with the system illustrated in FIG. 1, the information (data) relating to the roll angle of the drill head 1 is to be transmitted wirelessly, so that the information can be displayed to an operator involved in controlling the drill head 1. The roll angle must typically only be transmitted during a steering operation of the drill head 1, i.e., if the drill head is (rotationally) driven with a very low angular velocity or an angular velocity of zero. For transmitting the data relating to the roll angle during the steering operation of the drill head 1, the rotation frequency of the magnetic dipole 3 is decreased with the control unit 7 to a range where the rotation speed is relatively low (first partial range). Within this first partial range, the rotation frequency of the magnetic dipole 3 is further modulated with the control unit 7. However, the rotation frequency of the dipole 3 may also be changed in a partial range along another curve having an arbitrary shape, for example, along an exponentially increasing or decreasing curve. Preferably, the curve should be shaped so as to allow an unambiguous association; i.e., only a single value of the data type to be transmitted is associated with each value of the rotation frequency.

When the drill head 1 is at rest, i.e. not rotating, the value for the roll angle is constant. In this case, the frequency of the rotation of the dipole 3 can be simply adjusted along a predefined linear course to a value that corresponds to the roll angle. FIG. 3 shows an exemplary predefined frequency course for this situation, wherein the roll angle on the abscissa can also be subdivided into twelve segments corresponding to the divisions on the face of a clock, instead of into percentage values (see FIG. 1). The rotation frequency of the dipole 3 can be determined by evaluating the magnetic field with the receiving unit 6, and this value can be associated with the corresponding value for the roll angle.

The values of the roll angle of a rotating drill head 1 are cyclically repeating data. In some situations, the drill head 1 is driven with at a low rotation speed when still in the steering mode. In this operating mode, data relating to the roll angle should still be transmitted to the receiving unit 6, so that the rotation of the dipole 3 is still held in the first partial range characterized by a relatively low-frequency. In this situation, the rotation frequency of the dipole 3 may be particularly modulated in form of a sinusoidal oscillation. During one revolution of the drill head 1, the rotation frequency of the dipole is then changed according to the curve representing a full sinusoidal oscillation. A sinusoidal oscillation advantageously changes the rotation frequency continuously, preventing large jumps in the rotation speed. However, if the values relating to the roll angle are to be transmitted also for a rotating drill head based, for example, on the linear frequency dependence illustrated in FIG. 3, which is fundamentally possible, then the value for the rotation frequency of the dipole 3 would have to be reset to the original value after reaching 100%, i.e., following a complete revolution of the drill head 1. However, this would be associated with a rotation speed jump which should be avoided, if at all possible, and can frequently not be sufficiently satisfied due to the inertia of the rotating dipole 3. FIG. 2 shows the corresponding course of the modulated rotation frequency of the magnetic dipole 3 for a situation where the changing values relating to the roll angle should be transmitted in the steering mode with a rotating drill head 1. The roll angle of the drill head 1 which—for sake of simplicity—is subdivided into 12 segments (time), is measured by a roll sensor 8 (which also measures the number of revolutions of the drill head 1). The measured values from the roll sensor 8 are supplied to the control unit 7, so that the control unit 7 can produce a corresponding frequency modulation adapted to the roll angle. Due to the symmetry of a “normal” sinusoidal oscillation, the problem arises that two values for the roll angle can be associated with a certain frequency within this sinusoidal oscillation. To filter out this ambiguity, the sinusoidal frequency change of the rotation of the dipole 3 is additionally modulated by generating frequency plateaus at defined rotation speeds associated with a respective value for the roll angle, i.e., the frequency is no longer changed commensurate with the course of a normal sinusoidal change, but is held constant for a short defined time interval. As a result, a staircase-like frequency modulation resembling a sinusoidal fundamental oscillation is generated.

In a drilling operation of the drill head 1, i.e., when a straight drill path is desired, the drill head 1 is (relatively rapidly) rotationally driven in addition to the static advance, thereby compensating the lateral forces produced by the control surface 2 in the course of a complete revolution and generating the desired straight drill path. Because information about the roll angle is generally not of interest to the operator during a drilling operation, this information will typically not be transmitted. Instead, the rotation frequency of the dipole 3 is increased during a drilling operation by the control unit 7 to a second partial range with higher frequencies. According to the invention, the rotation frequency of the dipole is to be changed in this second partial range for then wirelessly transmitting data relating to a different data type. For example, values relating to a pulling force exerted on a pipe (not shown) attached to the drill head 1 and measured with a pulling force measuring device (not shown) may be transmitted. Because this value typically does not change in a cyclical fashion, the frequency can again be changed based on the course illustrated in FIG. 3, wherein instead of a percentage division on the abscissa, concrete values of the pulling force may, of course, also be associated with the values of the rotation frequency of the dipole 3.

Other data types, which may preferably be additionally transmitted, include the values for the state of charge of a battery provided for supplying power to, for example, the roll sensor, the pulling force measuring device or the rotary drive for the dipole, the ambient temperature, the operating temperature of the components arranged in the drill head, the prevailing pressure, etc.

What is claimed is:

1.-9. (canceled)

10. A method for transmitting data from a device to a receiving unit, comprising the steps of:
rotationally driving a magnetic dipole arranged in or on the device;
changing a rotation frequency of the magnetic dipole in a rotation speed range to generate a changing magnetic field representing the data, wherein the rotation speed range is subdivided into partial ranges, each partial range being associated with a corresponding data type;
receiving with the receiving unit the changing magnetic field; and
determining the data from the received changing magnetic field.

11. The method of claim 10, and further comprising the step of the linearly changing the frequency in a partial range of the rotation speed range when transmitting slowly changing values of the corresponding data type.

12. The method of claim 10, and further comprising the step of the sinusoidally changing the frequency in a partial range of the rotation speed range when transmitting cyclically changing values of the corresponding data type

13. The method of claim 12, and further comprising the step of additionally modulating the sinusoidally changing frequency in defined segments of a sinusoidal oscillation.

14. The method of claim 13, wherein the device is rotatable about an axis and the data relate to a rolling motion of the device, wherein the rolling motion is subdivided into defined roll values, with each roll value corresponding to an actual modulation of the sinusoidally changing frequency.

15. A method for operating a steerable earth working apparatus having a steering mode, wherein the earth working apparatus is rotationally driven either without rotation or with a rotation at a relatively low frequency, and an operating mode, wherein the earth working device is rotationally driven with a rotation at a relatively high frequency, comprising the steps of:
rotationally driving a magnetic dipole arranged in or on the earth working apparatus;
changing a rotation frequency of the magnetic dipole in a rotation speed range to generate a changing magnetic field representing data, wherein the rotation speed range is subdivided into partial ranges, each partial range being associated with a corresponding data type;
decreasing the rotation frequency of the magnetic dipole in the steering mode to a first partial range having the relatively low frequency and transmitting the data relating to roll of the earth drilling apparatus by changing the rotation frequency of the magnetic dipole at the relatively low frequency;
receiving with a receiving unit the changing magnetic field;
determining the data relating to roll from the received changing magnetic field, and
terminating transmission of the data relating to roll when the earth working apparatus is in the operating mode.

16. The method of claim 15, and further comprising the step of increasing the rotation frequency of the magnetic dipole in the operating mode to a second partial range having the relatively high frequency.

17. A system for transmitting data from a device to a receiving unit, comprising:
a magnetic dipole arranged in or on the device, wherein the magnetic dipole is rotationally driven by a drive in a rotation speed range which is subdivided into partial ranges, with each of the partial ranges being associated with a corresponding data type;
a control unit changing the rotation frequency of the magnetic dipole; and
the receiving unit receiving and evaluating a magnetic field of the magnetic dipole.

18. The system of claim 17, wherein the device and the magnetic dipole have parallel or coaxial rotation axes, and wherein the device is constructed to be rotationally driven independent of the magnetic dipole.
